(19) United States
(12) Patent Application Publication
(10) Pub. No.: US 2002/0076586 A1
(43) Pub. Date: Jun. 20, 2002

(54) Fuel cell and fuel cell system

(76) Inventor: Koichi Tanaka, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/992,971

(22) Filed: Nov. 14, 2001

(30) Foreign Application Priority Data
Nov. 21, 2000 (JP) P2000-354061

(51) Int. Cl. H01M 8/10

(52) U.S. Cl. 429/19; 429/31; 429/32

(57) ABSTRACT

The present invention provides an electrochemical device capable of improving the usability for portable devices, enhancing the degree of freedom in layout of the electrochemical device, and facilitating the packaging of the electrochemical device as a product, and a power generator and a power generation system using the electrochemical devices. The electrochemical device includes a hydrogen absorber, a fuel electrode, an ion exchange membrane, and an oxygen electrode. The fuel electrode and said fuel source constitute a fuel electrode assembly in a state being in contact with each other. The fuel electrode assembly is surrounded by said ion exchange membrane in a state being in contact with said ion exchange membrane. The ion exchange membrane is surrounded by said oxygen electrode in a state being in contact with said oxygen electrode. The electrochemical device can output an electric power by supplying hydrogen absorbed in the hydrogen absorber as a fuel to the fuel electrode.

### BACKGROUND OF THE INVENTION

The present invention relates to an electrochemical device, and a power generator and a power generation system using the electrochemical devices, and particularly to an electrochemical device having a function of a portable fuel cell, and a power generator and a power generation system using the electrochemical devices.

Fuel cells are known of a type in which a fuel electrode is connected to an oxygen electrode via an ion exchange membrane. In the fuel cell of this type, a fuel such as hydrogen gas is supplied from a fuel supply apparatus, which is provided outside the fuel cell, to the fuel electrode for generating hydrogen ions, that is, protons in the fuel electrode.

A fuel cell including a fuel electrode, an oxygen electrode, and an ion exchange membrane, each of which is formed into a hollow cylinder shape, is described in U.S. Pat. No. 6,060,188. In this fuel cell, a round column shaped porous base is surrounded by the fuel electrode in a state being in contact with the fuel electrode, the fuel electrode is surrounded by the ion exchange membrane in a state being in contact with the ion exchange membrane, and the ion exchange membrane is surrounded by the oxygen electrode in a state being in contact with the oxygen electrode. The porous base, the fuel electrode, the ion exchange membrane, and the oxygen electrode are coaxially disposed.

In the above-described fuel cell, a fuel supply apparatus must be additionally provided outside the fuel cell for supplying a fuel in the fuel cell. As a result, the size of the system composed of the fuel cell and the fuel supply apparatus becomes large, and therefore, it is difficult to use the fuel cell of this type for portable devices.

As a fuel cell not required to be provided with any fuel supply apparatus outside the fuel cell, there is known a fuel cell of a type having a fuel source in the fuel cell. A fuel cell having an approximately rectangular parallelopiped housing filled with a hydrogen absorber as a fuel source is described in U.S. Pat. No. 6,080,501. In this fuel cell, a round column shaped porous base is surrounded by an oxygen electrode in a state being in contact with the oxygen electrode, the oxygen electrode is surrounded by an ion exchange membrane in a state being in contact with the ion exchange membrane, the ion exchange membrane is surrounded by a fuel electrode in a state being in contact with the fuel electrode, and the fuel electrode is surrounded by a hydrogen absorber in a state being in contact with the hydrogen absorber. A round column shaped member is composed of the porous base, the oxygen electrode, the ion exchange membrane, and the fuel electrode, which are coaxially disposed. A plurality of the round column shaped member are provided in such a manner as to pass through the housing filled in the hydrogen absorber.

The fuel cell described in U.S. Pat. No. 6,080,501, however, has a problem that since the approximately parallelopiped housing is filled with the hydrogen absorber as the fuel source, in the case of using a plurality of fuel cells, there is a limitation to a layout of the fuel cells; it is not easy to package the fuel cells as a product, and the degree of freedom in module is low.

### SUMMARY OF THE INVENTION

An object of the present invention is to provide an electrochemical device capable of improving the usability for portable devices, enhancing the degree of freedom in layout of the electrochemical device, and facilitating the packaging of the electrochemical device as a product, and to provide a power generator and a power generation system using the electrochemical devices.

To achieve the above object, according to a first aspect of the present invention, there is provided an electrochemical device including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; wherein the fuel electrode and the fuel source constitute a fuel electrode assembly in a state being in contact with each other; the fuel electrode assembly is surrounded by the ion exchange membrane in a state being in contact with the ion exchange membrane; and the ion exchange membrane is surrounded by the oxygen electrode in a state being in contact with the oxygen electrode.

With this configuration, the electrochemical device can be taken as a fuel cell capable of making the degree of freedom in shape higher than that of a related art flat type fuel cell while keeping the same power generation function as that of the related art flat type fuel cell, and can enhance a packaging characteristic in providing the fuel electrode and the fuel source in the electrochemical device.

The fuel source is preferably allowed to absorb a liquid fuel or hydrogen gas. Further, the fuel source is preferably composed of a hydrogen absorber made from carbon based fullerene molecules, carbon nanotubes, carbon nanofibers, or a metal hydride. In addition, as the metal hydride, there is typically used a hydrogen absorbing alloy or the like.

With this configuration, it is possible to supply a fuel to the fuel electrode without the need of provision of any apparatus for supplying a fuel such as hydrogen, and hence to ensure a function of a fuel cell usable for portable devices.

Preferably, the fuel electrode assembly is formed into a round column shape, and each of the ion exchange membrane and the oxygen electrode is formed into a hollow cylinder shape. Further, preferably, the fuel source is formed into a round column shape and the fuel electrode is formed into a hollow cylinder shape, and the fuel source is surrounded by the fuel electrode in a state being in contact with the fuel electrode.

With this configuration, the electrochemical device can be formed into a round column shape similar to that of a related art dry cell, and can be handled in the same manner as that for the related art dry cell. Further, since the electrochemical device is formed into a round column shape, it is possible to enhance the degree of freedom in layout in the case of connecting a plurality of the electrochemical devices.

The ion exchange membrane preferably has a porous matrix which is filled with the proton conductor.

With this configuration, the ion exchange membrane can be easily formed into a solid membrane using a proton conductor even if the proton conductor is difficult to be formed into a film.

The ion exchange membrane is preferably formed by mixing the proton conductor with a binder and forming the mixture into a film shape.

With this configuration, the ion exchange membrane can be easily formed into a solid membrane using a proton conductor even if the proton conductor is difficult to be formed into a film.

The proton conductor is preferably formed by introducing proton dissociative groups in a base body composed of a carbonaceous material containing carbon as a main component. Here, the wording “dissociation of protons” means that protons (H⁻) are dissociated by ionization, and the wording “proton dissociative groups” means function groups from which protons are dissociated by ionization. The proton conductor is preferably formed of an electrolyte membrane which does not require water management. The electrolyte membrane is preferably a self-humidifying type solid polymer membrane. Further, the electrolyte membrane is preferably made from a proton conductive inorganic compound.

With this configuration, it is possible to conduct protons without the need of provision of any humidifier.

To achieve the above object, according to a second aspect of the present invention, there is provided a power generator having a plurality of electrochemical devices, each of the electrochemical devices including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; the plurality of electrochemical devices being electrically connected to each other by means of a conductive connection pattern; wherein the fuel electrode and the fuel source in at least one of the electrochemical devices constitute a fuel electrode assembly in a state being in contact with each other; the fuel electrode assembly in at least one of the electrochemical devices is surrounded by the ion exchange membrane in a state being in contact with the ion exchange membrane; and the ion exchange membrane in at least one of the electrochemical devices is surrounded by the oxygen electrode in a state being in contact with the oxygen electrode.

With this configuration, it is possible to obtain a high output as a total output from the plurality of electrochemical devices, and to enhance the degree of layout of the electrochemical devices in the case of producing the power generator.

To achieve the above object, according to a third aspect of the present invention, there is provided a power generation system having a plurality of electrochemical devices, each of the electrochemical devices including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; the plurality of electrochemical devices being electrically connected to each other by means of a conductive connection pattern; wherein the plurality of electrochemical devices and the conductive connection pattern are disposed in a housing; and wherein the fuel electrode and the fuel source in at least one of the electrochemical devices constitute a fuel electrode assembly in a state being in contact with each other; the fuel electrode assembly in at least one of the electrochemical devices is surrounded by the ion exchange membrane in a state being in contact with the ion exchange membrane; and the ion exchange membrane in at least one of the electrochemical devices is surrounded by the oxygen electrode in a state being in contact with the oxygen electrode.

The housing is preferably provided with an oxygen supply passage or an air supply passage for supplying oxygen or air to the electrochemical devices, and a fuel filling port for supplying a fuel to the fuel sources. The hydrogen filling port used as the hydrogen supply mechanism for supplying hydrogen serves as a hydrogen filling mechanism.

With this configuration, it is possible to easily supply oxygen in air into the power generation system, and to realize a rechargeable power generation system.

To achieve the above object, according to a fourth aspect of the present invention, there is provided an electrochemical device including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; wherein the oxygen electrode is surrounded by the ion exchange membrane in a state being in contact with the ion exchange membrane; and the ion exchange membrane is surrounded by the fuel electrode in a state being in contact with the fuel electrode; and wherein the fuel electrode and the fuel source constitute a fuel electrode assembly in a state being in contact with each other; and the fuel electrode assembly surrounding the oxygen electrode acts only on the oxygen electrode.

With this configuration, the electrochemical device can be taken as a compact fuel cell capable of making the degree of freedom in shape higher than that of a related art flat type fuel cell while keeping the same power generation function as that of the related art flat type fuel cell, and can enhance a packaging characteristic in providing the fuel electrode and the fuel source in the electrochemical device.

The fuel source is preferably allowed to absorb a liquid fuel or hydrogen gas. Further, the fuel source is preferably composed of a hydrogen absorber made from carbon based fullerene molecules, carbon nanotubes, carbon nanofibers, or a metal hydride.

With this configuration, it is possible to supply a fuel to the fuel electrode without the need of provision of any apparatus for supplying a fuel such as hydrogen, and hence to ensure a function of a fuel cell usable for portable devices.

Each of the fuel electrode assembly, the ion exchange membrane, and the oxygen electrode is preferably formed into a hollow cylinder shape. Further, preferably, each of the fuel source and the fuel electrode is formed into a hollow cylinder shape, and the fuel electrode is surrounded by the fuel source in a state being in contact with the fuel source.

With this configuration, the electrochemical device can be formed into a round column shape similar to that of a related art dry cell, and can be handled in the same manner as that for the related art dry cell. Further, since the electrochemical device is formed into a round column shape, it is possible to enhance the degree of freedom in layout in the case of connecting a plurality of electrochemical devices.

The ion exchange membrane preferably has a porous matrix which is filled with the proton conductor.

With this configuration, the ion exchange membrane can be easily formed into a solid membrane using a proton conductor even if the proton conductor is difficult to be formed into a film.

The ion exchange membrane is preferably formed by mixing the proton conductor with a binder and forming the mixture into a film shape.

With this configuration, the ion exchange membrane can be easily formed into a solid membrane using a proton conductor even if the proton conductor is difficult to be formed into a film.

The proton conductor is preferably formed by introducing proton dissociative groups in a base body composed of a carbonaceous material containing carbon as a main component. The proton conductor is preferably formed of an electrolyte membrane which does not require water management. The electrolyte membrane is preferably a self-humidifying type solid polymer membrane. Further, the electrolyte membrane is made from a proton conductive inorganic compound.

With this configuration, it is possible to conduct protons without the need of provision of any humidifier.

To achieve the above object, according to a fifth aspect of the present invention, there is provided a power generator having a plurality of electrochemical devices, each of the electrochemical devices including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; wherein the oxygen electrode in at least one of the plurality of electrochemical devices is surrounded by the ion exchange membrane in a state being in contact with the ion exchange membrane; and the ion exchange membrane in at least one of the plurality of electrochemical devices is surrounded by the fuel electrode in a state being in contact with the fuel electrode; and wherein the fuel electrode and the fuel source in at least one of the electrochemical devices constitute a fuel electrode assembly in a state being in contact with each other; the plurality of electrochemical devices are electrically connected to each other by means of a conductive connection pattern; and the fuel electrode assembly surrounding one of the oxygen electrodes acts only on the one of the oxygen electrodes.

With this configuration, it is possible to obtain a high output as a total output from the plurality of electrochemical devices, and to enhance the degree of layout of the electrochemical devices in the case of producing the power generator.

According to a sixth aspect of the present invention, there is provided a power generation system having a plurality of electrochemical devices, each of the electrochemical devices including: a fuel electrode which becomes a negative electrode while accompanying generation of hydrogen; an oxygen electrode provided so as to be allowed to be in contact with oxygen, which becomes a positive electrode while accompanying generation of water from oxygen molecules, the hydrogen ions, and electrons; an ion exchange membrane for conducting the hydrogen ions in the fuel electrode into the oxygen electrode, the ion exchange membrane having a proton conductor; and a fuel source for supplying a fuel so as to generate the hydrogen ions in the fuel electrodes; wherein the oxygen electrode in at least one of the plurality of electrochemical devices is surrounded by the ion exchange membrane in a state being in contact with the ion exchange membrane; and the ion exchange membrane in at least one of the plurality of electrochemical devices is surrounded by the fuel electrode in a state being in contact with the fuel electrode; and wherein the fuel electrode and the fuel source in at least one of the electrochemical devices constitute a fuel electrode assembly in a state being in contact with each other; the plurality of electrochemical devices are electrically connected to each other by means of a conductive connection pattern; the fuel electrode assembly surrounding one of the oxygen electrodes acts only on the one of the oxygen electrodes; and the plurality of electrochemical devices and the conductive connection pattern are disposed in a housing.

With this configuration, it is possible to realize a compact, portable power generation system having the plurality of the electrochemical devices.

The housing is provided with an oxygen supply passage or an air supply passage for supplying oxygen or air to the electrochemical devices, and a fuel filling port for supplying a fuel to the fuel sources. The hydrogen filling port used as the hydrogen supply mechanism for supplying hydrogen serves as a hydrogen filling mechanism.

With this configuration, it is possible to easily supply oxygen in air into the power generation system, and to realize a rechargeable power generation system.

### BRIEF DESCRIPTION OF THE DRAWINGS

FIG. 1 is sectional view showing an electrochemical device according to a first embodiment of the present invention;

FIG. 2 is a sectional view showing a power generator according to a second embodiment of the present invention;

FIG. 3 is a sectional view showing a power generation system according to a third embodiment of the present invention;

FIG. 4 is a diagram showing structures of fullerene molecules used as a proton conductor of the electrochemical device according to the first embodiment of the present invention;

FIG. 5 is a diagram showing structures of carbon clusters each having a spherical structure, a spheroid structure, or a closed face structure similar to the spherical or spheroid structure, which clusters are usable as the proton conductor of the electrochemical device of the first embodiment of the present invention;

FIG. 6 is a diagram showing structures of carbon clusters each having a spherical structure, part of which is lost and which has open ends, which clusters are usable as the proton conductor of the electrochemical device according to the first embodiment of the present invention;

FIG. 7 is a diagram showing structures of carbon clusters each having a diamond structure in which most of carbon atoms are bonded to each other in an Sp³ bonding manner, which clusters are usable as the proton conductor of the electrochemical device according to the first embodiment of the present invention; and

FIG. 8 is a diagram showing structures of carbon clusters each having a structure in which a plurality of cluster structures are variously bonded to each other, which clusters are usable as the proton conductor of the electrochemical device according to the first embodiment of the present invention.

### DETAILED DESCRIPTION OF THE PREFERRED EMBODIMENTS

Hereinafter, embodiments of the present invention will be described with reference to the accompanying drawings.

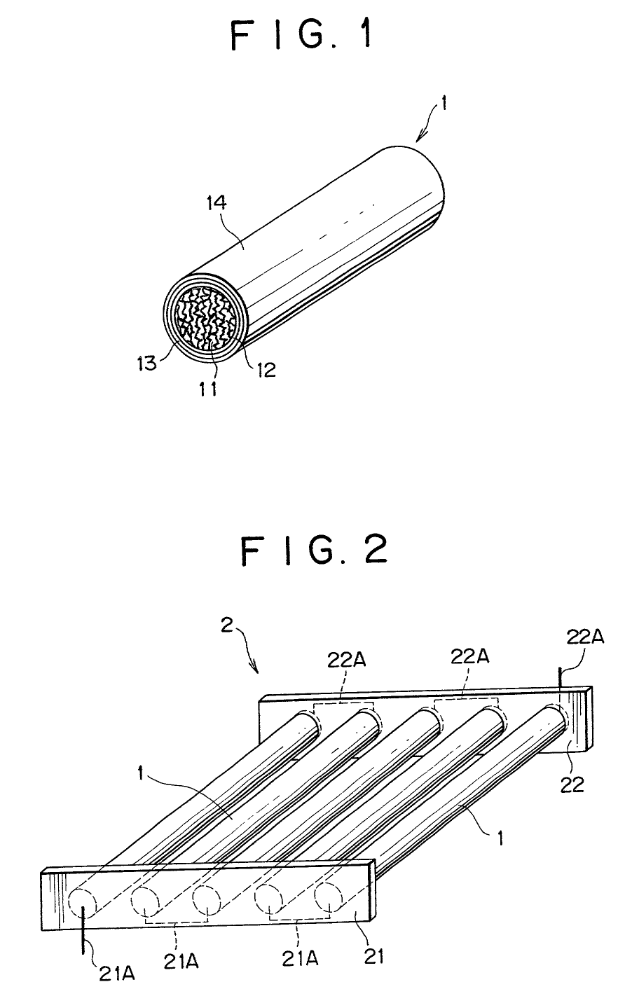

A first embodiment in which the present invention is applied to an electrochemical device will be described with reference to FIG. 1.

An electrochemical device 1 according to this embodiment includes a round column shaped hydrogen absorber 11, and a fuel electrode 12, an ion exchange membrane 13, and an oxygen electrode 14, each of which is formed into a hollow cylinder shape. An outer periphery of the hydrogen absorber 11 is surrounded by the fuel electrode 12 in a state being in contact with an inner periphery of the fuel electrode 12. An outer periphery of the fuel electrode 12 is surrounded by the ion exchange membrane 13 in a state being in contact with an inner periphery of the ion exchange membrane 13. An outer periphery of the ion exchange membrane 13 is surrounded by the oxygen electrode 14 in a state being in contact with an inner periphery of the oxygen electrode 14. The hydrogen absorber 11, the fuel electrode 12, the ion exchange membrane 13, and the oxygen electrode 14 are coaxially disposed, and constitute the round column shaped electrochemical device 1 having a function of a fuel cell.

The hydrogen absorber 11 is made from carbon based fullerene molecules, carbon nanotubes, or carbon nanofibers. The hydrogen absorber 11 acts as a fuel source for absorbing and supporting hydrogen, which has been supplied from external, therein and supplying hydrogen to the fuel electrode 12. Here, the wording “absorb and support hydrogen, which has been supplied from external, therein” is not necessarily limited to a meaning “absorb and support hydrogen, which has been supplied from external as hydrogen molecules, in the state of hydrogen molecules”, but contains a meaning “absorb and store hydrogen, which has been supplied from external as hydrogen molecules, in a specific converted state depending on the kind of a material forming the hydrogen absorber 11”. Further, the wording “supply hydrogen to the fuel electrode 12” is not necessarily limited to a meaning “supply hydrogen to the second electrode 12 in the state of hydrogen molecules” but contains a meaning “supply hydrogen, which has been absorbed and stored in the hydrogen absorber 11 in the specific converted state, to the fuel electrode 12 in a specific state allowing the fuel electrode 12 to generate hydrogen ions, that is, protons”.

The fuel electrode 12 is formed by a carbon particle layer in which a platinum (Pt) catalyst is supported. The carbon particle layer is impregnated with a proton conductor. The proton conductor is formed by introducing proton dissociative groups in a base body composed of a carbonaceous material containing carbon as a main component. According to this embodiment, as the proton conductor, there is used a fullerene derivative based proton conductor, for example, polyfullerene hydroxide. Since the fuel electrode 12 is impregnated with a fullerene derivative based proton conductor functioning as an ion conductor, it is possible to desirably keep the ion conductivity in the fuel electrode 12 even in a fuel non-humidified state, and to make the fullerene derivative based proton conductor conformable to the platinum catalyst. The fuel electrode 12 is disposed so as to surround the outer periphery of the hydrogen absorber 11. The fuel electrode 12 and the hydrogen absorber 11 act as a fuel electrode assembly as a whole.

The fullerene derivative based proton conductor used herein contains, as a base body, fullerene molecules in the form of spherical cluster molecules, which are generally selected from C₃₆, C₆₀, C₇₀, C₇₆, C₇₈, C₈₀, C₈₂, C₈₄, and the like. In this embodiment, C₆₀ and C₇₀ are selected as the fullerene molecules. Proton dissociative groups and further electron attractive groups are introduced to carbon atoms constituting each of the fullerene molecules thus selected, to form the fullerene derivative based proton conductor suitable for the present invention. The proton dissociative groups mean function groups from which hydrogen ions (protons, H⁺) are dissociated by ionization. Examples of kinds of the proton dissociative groups include —OH, —OSO₃H, —COOH, —SO₃H, and —OPO(OH)₂, and according to this embodiment, —OH or —OSO₃H is preferably used. In particular, a membrane formed by polyfullerene hydroxide (often called fullerenol) having —OH groups as the proton dissociative groups is superior to a membrane formed by the related art material, for example, perfluorosulfonic acid resin in terms of film formation characteristic or the like, and the membrane does not require a humidifier or the like because the conduction of protons do not require the aid of water molecules. The membrane formed by fullerenol is further advantageous in that it can be operated in a wide operational temperature range of −40° C. to 160° C. For these reasons, the membrane formed by fullerenol is suitable for the electrochemical device (fuel cell) of the present invention. Examples of kinds of the electron attractive groups include a nitro group, a carbonyl group, a carboxyl group, a nitrile group, an alkyl halide group, and a halogen atom (for example, fluorine atom or chlorine atom). These groups and halogen atoms may be used singly or in combination.

The oxygen electrode 14 is also formed by a carbon particle layer in which the platinum (Pt) catalyst is supported. Like the carbon particle layer of the fuel electrode 12, the carbon particle is impregnated with a fullerene derivative based proton conductor. Since the oxygen electrode 14 is positioned at the outermost portion of the round column shaped electrochemical device 1, oxygen in air outside the electrochemical device 1 is allowed to be permeated in the carbon particle layer of the oxygen electrode 14. Oxygen in air comes in contact with the catalyst in the oxygen electrode 14, and at the oxygen electrode 14, water is generated by reaction of hydrogen ions, which have been generated at the fuel electrode 12 and conducted to the oxygen electrode 14 via the ion exchange membrane 13, oxygen molecules, and electrons supplied via an external circuit (not shown). Since the oxygen electrode 14 is impregnated with the fullerene derivative based proton conductor as the ion exchange conductor, it is possible to desirably keep the ion conductivity in the oxygen electrode 14 even in a fuel non-humidified state and to make the fullerene derivative based proton conductor conformable to the platinum catalyst.

A fullerene derivative based proton conductor is also used for the ion exchange membrane 13. To be more specific, the ion exchange membrane 13 is formed by filling a porous matrix, which is made from polyethylene (PE), polypropylene (PP), or polytetrafluoroethylene (PTFE), with the fullerene derivative based proton conductor. That is to say, the ion exchange membrane 13 is in the form of a solid membrane filled with the fullerene derivative based proton conductor. According to this embodiment, since the ion exchange membrane 13 is formed as the solid membrane, the hydrogen absorber 11 in the form of particles can be kept in a round column shape by disposing the hollow cylinder shaped solid ion exchange membrane 13 in such a manner that the hydrogen absorber 11 and the fuel electrode 12 are surrounded with the ion exchange membrane 13. This makes it possible to obtain the electrochemical device 1 exhibiting a function of a portable fuel cell. Further, since the ion exchange membrane 13 is formed by filling the porous matrix with a proton conductor, it is possible to easily obtain a solid ion exchange membrane by using a proton conductor, even if the proton conductor is poor in film formation characteristic.

The electrochemical device 1 having a function of a fuel cell is configured, as described above, such that the hydrogen absorber 11 is surrounded with the fuel electrode 12 in the state being in contact with the fuel electrode 12, the fuel electrode 12 is surrounded with the ion exchange membrane 13 in the state being in contact with the ion exchange membrane 13, and the ion exchange membrane 13 is surrounded with the oxygen electrode 14 in the state being in contact with the oxygen electrode 14. As a result, the electrochemical device 1 can be formed into any shape other than a flat shape of a related art fuel cell.

A second embodiment, in which the present invention is applied to a power generator, will be described below with reference to FIG. 2.

A power generator 2 according to this embodiment includes five pieces of the electrochemical devices 1 according to the first embodiment, and two end plates 21 and 22. A conductive connection pattern 21A is provided in the end plate 21, and a conductive connection pattern 22A is provided in the end plate 22. The five electrochemical devices 1 are electrically connected to each other via the conductive connection patterns 21A and 22A.

The five electrochemical devices 1, each of which has the same diameter and the same longitudinal length, are provided with their longitudinal axes disposed in parallel to each other. The five electrochemical devices 1 are supported with one-ends fixed to the end plate 21 and the other ends fixed to the end plate 22, and are electrically connected in series to each other by the conductive connection patterns 21A and 22A which are provided in the end plates 21 and 22, respectively. To be more specific, on the end plate 21 side, at one end of the left end electrochemical device 1 in FIG. 2, only the oxygen electrode 14 (see FIG. 1 is connected to the conductive connection pattern 21A in the end plate 21, and extends to the outside of the power generator 2 to be taken as a plus electrode. On the end plate 22 side, at the other end of the left end electrochemical device 1 in FIG. 2, the fuel electrode 12 (see FIG. 1) is connected to the oxygen electrode 14 (see FIG. 1) of the right side electrochemical device 1 adjacent to the left end electrochemical device 1 in FIG. 2 via the conductive connection pattern 22A in the end plate 22. The connection between the oxygen electrode 14 and the fuel electrode of the two electrochemical devices 1 adjacent to each other is repeated, whereby the five electrochemical devices 1 are electrically connected in series to each other.

Since the power generator 2 is produced by connecting the plurality of electrochemical devices 1 to each other via the conductive connection patterns 21A and 22A, it is possible for the power generator 2 to ensure a high output as a total output from the plurality of electrochemical devices 1, and to enhance the degree of freedom in layout of the electrochemical devices 1 in the case of producing the power generator 2.

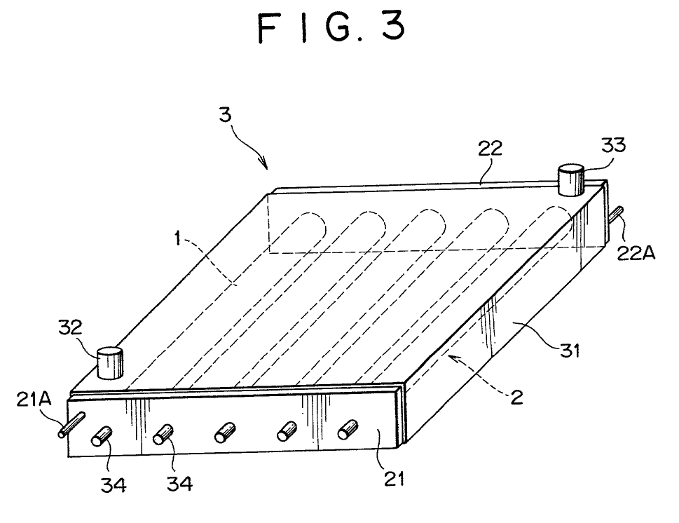

A third embodiment, in which the present invention is applied to a power generation system, will be described below with reference to FIG. 3. A power generation system 3 according to the third embodiment has the power generator 2 produced according to the second embodiment. The power generation system 3 has a housing 31 formed into an approximately rectangular parallelopiped shape. Specifically, with respect to the rectangular parallelopiped power generation system 3, four planes (top plane, bottom plane, and two side planes) parallel to the axial directions of the electrochemical devices 2 are formed by planes of the housing 31, and the remaining two planes (front plane and rear plane) are formed by the end plates 21 and 22 of the power generator 2. A through-hole (not shown) for sucking air in the housing 31 is formed in the vicinity of one corner of the upper surface of the rectangular parallelopiped housing 31. A cylindrical air supply passage portion 32 for allowing permeation of oxygen in air in the housing 31 is provided at the through-hole.

A though-hole (not shown) is formed in the vicinity of a corner position, diagonal to the position at which the air supply passage portion 32 is provided, of the upper surface of the rectangular parallelopiped housing 31. A cylindrical air discharge passage portion 33 having the same configuration as that of the air supply passage portion 32 is provided at the through-hole. The air discharge passage portion 33 is configured to allow discharge of air in the housing 31 to the outside of the power generation system 3.

A through-hole (not shown) for filling the hydrogen absorber 11 of each of the electrochemical devices 1 with hydrogen is formed at a position on the front surface side of the end plate 21, at which one end of the electrochemical device 1 is brought into contact with the end plate 21. A cylindrical hydrogen filling port portion 34 is provided at the through-hole. A tubular member (not shown) extending from a hydrogen supply mechanism (not shown) is connected to each of the hydrogen filling port portion 34, to supply hydrogen into the hydrogen absorber 11 of the corresponding electrochemical device 1 through the hydrogen filling port portion 34.

The power generator 2 is thus configured as a unit providing the housing 31, to realize the power generation system 3 of a portable type. The power generation system 3 can be merchandized as a unit. Further, since each hydrogen absorber 11 can be filled with hydrogen through the hydrogen filling port portion 34, the power generation system 3 including a unit configuration having a function of fuel cells can be configured as a so-called chargeable type power generation system.

The electrochemical device, the power generator, and the power generation system according to the present invention are not limited to the above-described embodiments but may be variously modified and improved without departing from the scope of the claims. For example, although the electrochemical device is formed into a round column shape in the first embodiment, the present invention is not limited thereto but may be configured such that the electrochemical device be formed into a square or triangular column shape. Alternatively, the electrochemical device may be formed into a spherical shape having a layer structure in which the hydrogen absorber, the fuel electrode, the ion exchange membrane, and the oxygen electrode are stacked in this order from the center.

In the first embodiment, each of the fuel electrode 12 and the oxygen electrode 14 is formed by the carbon particle layer in which the Pt catalyst is supported and the carbon particle layer is impregnated with the fullerene derivative based proton conductor; however, the carbon particle layer may be not necessarily impregnated with the proton conductor. Further, each of the fuel electrode 12 and the oxygen electrode 14 may be formed by impregnating a hollow cylinder shaped porous carbon (for example, carbon sheet or carbon cloth) with the electrode material. With this configuration, each of the fuel electrode 12 and the oxygen electrode 14 can be configured to have a structure being rigid enough to keep its hollow cylinder shape.

In the first embodiment, the fuel electrode is formed into a hollow cylinder shape and the hydrogen absorber as a fuel source is formed into a round column shape, and the hydrogen absorber is surrounded by the fuel electrode in such a manner as to be brought into contact therewith, to form a fuel electrode assembly; however, the present invention is not limited thereto but may be configured such that the fuel electrode and the fuel source are unified in a state being in contact with each other, to form a fuel electrode formed body. That is to say, each of the fuel electrode and the fuel source may be formed in any shape insofar as the fuel electrode is in contact with both the fuel source and the ion exchange membrane. For example, the fuel electrode may be entrapped in the fuel source, so that both the fuel electrode and the fuel source may be integrated with each other as viewed from external.

The first embodiment may be modified such that the oxygen electrode be surrounded by the ion exchange membrane in a state being in contact with the ion exchange membrane, the ion exchange membrane be surrounded by the fuel electrode in a state being in contact with the fuel electrode, and the fuel electrode be surrounded by the hydrogen absorber in a state being in contact with the hydrogen absorber. In this case, the fuel electrode and the hydrogen absorber may be formed into the above-described fuel electrode formed body. Also, each of the oxygen electrode, the ion exchange membrane, and the fuel electrode formed body may be formed into a hollow cylinder shape. Further, the hydrogen absorber which surrounds the oxygen electrode via the fuel electrode and the ion exchange membrane may be configured to act only on the oxygen electrode. With this configuration of the modification, it is possible to take the small-sized electrochemical device as a single fuel cell and hence to enhance the degree of freedom in packaging.

In the electrochemical device according to the first embodiment, the ion exchange membrane is formed by impregnating the porous base body with the fullerene derivative based proton conductor; however, the ion exchange membrane may be replaced with a so-called self-humidifying type solid polymer membrane in which a trace of a catalyst composed of ultrafine particles of platinum and also ultrafine particles of an oxide such as TiO₂ or SiO₂ are densely dispersed, or a polymer membrane to which a proton conductive inorganic compound such as phosphoric acid-silicate (P₃O₅—SiO₂) based glass is added. Like the electrochemical device according to the first embodiment, the use of such a membrane makes it possible to eliminate the need of giving moisture to a fuel by a humidifier or the like.

The ion exchange membrane may be formed by mixing the proton conductor with a resin based binder and forming the mixture into a film shape, or may be formed in accordance with any other known production method.

According to the first embodiment, the ion exchange membrane is formed by filling the porous matrix with the proton conductor; however, the present invention is not limited thereto but may be configured such that the ion exchange membrane be formed by a solid membrane having a proton conductivity and capable of setting the fuel source in the form of particles or the like at a desired position.

According to the first embodiment, hydrogen gas is supplied as a fuel; however, the present invention is not limited thereto but may be configured such that alcohol such as methanol or any other fossil fuel be directly supplied in a liquid or gas state, so that protons be generated from the fuel material by the presence of the catalyst at the fuel electrode. In this case, the hydrogen absorber provided in the electrochemical device according to the first embodiment may be replaced with a fuel source capable of absorbing alcohol, a fossil fuel, or the like.

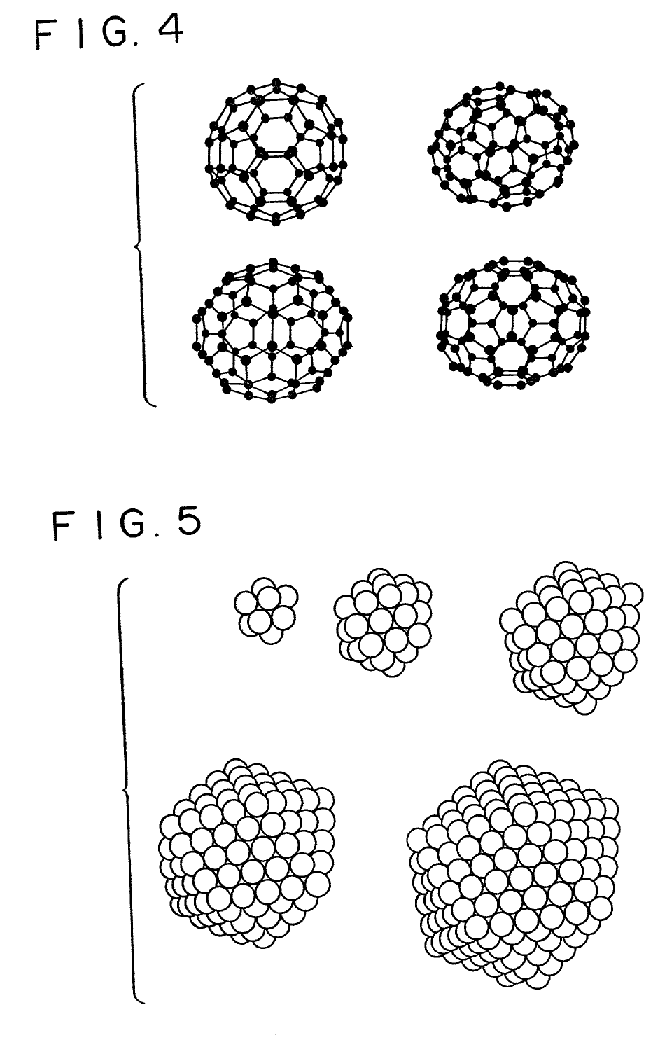

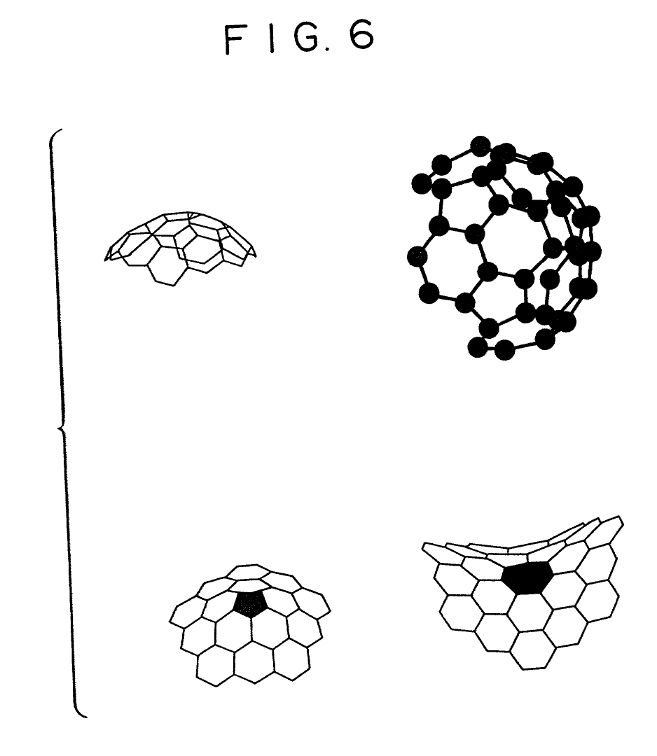

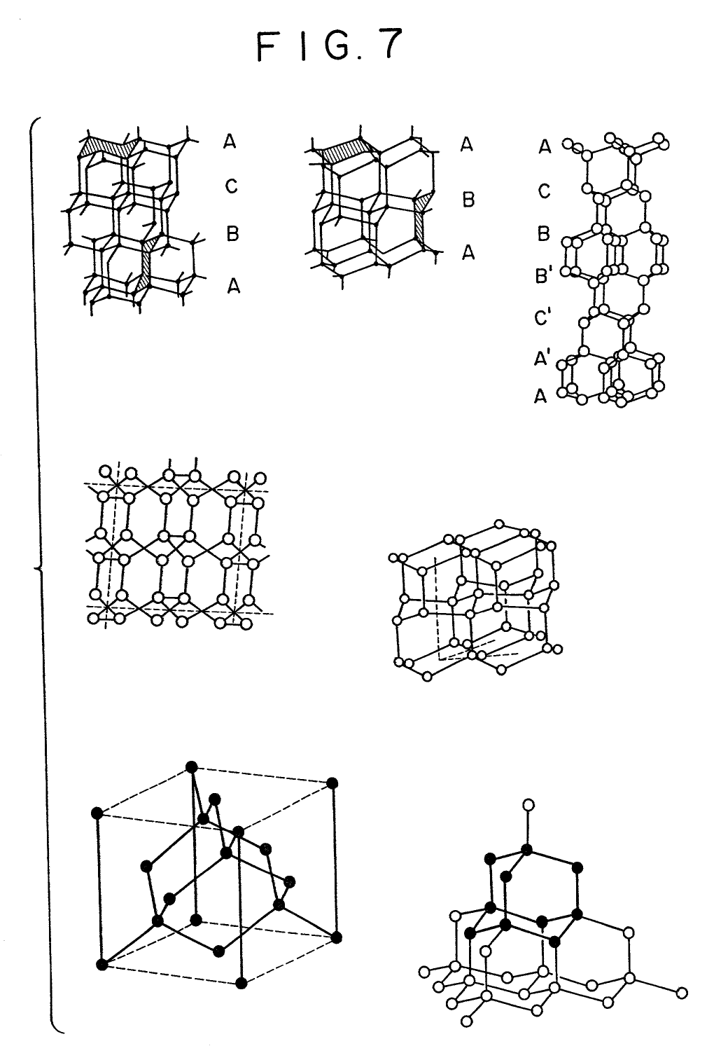

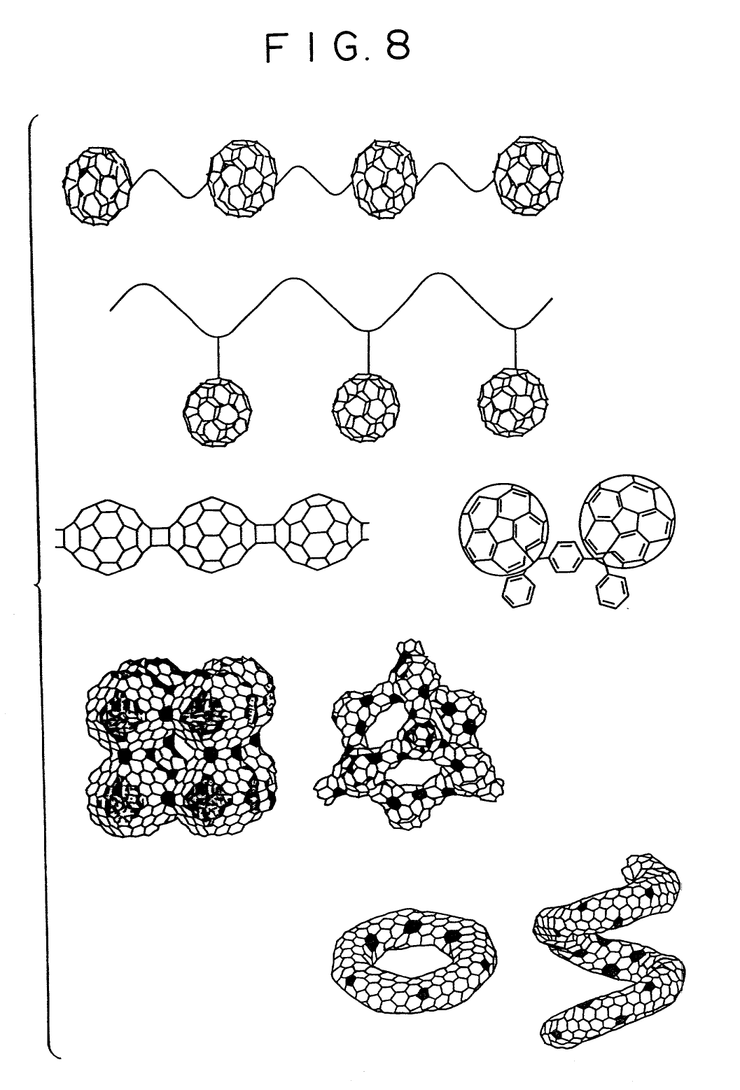

According to the first embodiment, polyfullerene hydroxide (generally called fullerenol) is used as the proton conductor forming an ion exchange membrane allowing conduction of protons in a non-humidified state; however, the present invention is not limited thereto. Polyfullerene contains fullerene molecules shown in FIG. 4 as a base body, wherein hydroxyl groups are introduced in carbon atoms of each of the fullerene molecules. The base body of the proton conductor, however, may be configured as a carbonaceous material containing carbon as a main component. Examples of the carbonaceous materials include a carbon cluster, that is, an aggregate in which carbon atoms of several to several hundreds are bonded to each other irrespective of the kind of carbon-carbon bonding, and carbonaceous tubes (generally called carbon nanotubes). Examples of the carbon clusters include a carbon cluster composed of an aggregate of a number of carbon atoms, which has a spherical structure, a spheroid structure, or a closed face structure similar to the spherical or spheroid structure (see FIG. 5), a carbon cluster having a spherical structure, part of which is lost and which has open ends (see FIG. 6), a carbon cluster having a diamond structure in which most of carbon atoms are bonded to each other in an SP³ bonding manner (see FIG. 7), and a carbon cluster having a structure in which the above clusters are variously bonded to each other (see FIG. 8).

The kind of proton dissociative group to be introduced in the above-described base body of the proton conductor is not limited to the above-described hydroxyl group but may be a group expressed by —XH, more preferably, —YOH, wherein each of X and Y is an arbitrary atom or an atomic group having bivalent bonds, and H and O designate a hydrogen atom and an oxygen atom, respectively. Specifically, in addition to the above-described —OH group, either of a hydrogen sulfate group (—OSO₃H), a carboxyl group (—COOH), a sulfone group (—SO₃H),and a phosphate group (—OPO(OH)₂) is preferably used as the proton dissociative group to be introduced in the base body of the proton conductor.

Even in the case of using any of the above-described ion proton conductors, the conduction of protons does not require the aid of a humidifier, and therefore, it is possible to obtain the same effect as that of each of the above-described embodiments.

What is claimed is:

1. An electrochemical device comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
wherein said fuel electrode and said fuel source constitute a fuel electrode assembly in a state being in contact with each other;
said fuel electrode assembly is surrounded by said ion exchange membrane in a state being in contact with said ion exchange membrane; and
said ion exchange membrane is surrounded by said oxygen electrode in a state being in contact with said oxygen electrode.

2. An electrochemical device according to claim 1, wherein said fuel source is allowed to absorb a liquid fuel or hydrogen gas.

3. An electrochemical device according to claim 2, wherein said fuel source is composed of a hydrogen absorber made from carbon based fullerene molecules, carbon nanotubes, carbon nanofibers, or a metal hydride.

4. An electrochemical device according to claim 1, wherein said fuel electrode assembly is formed into a round column shape; and
each of said ion exchange membrane and said oxygen electrode is formed into a hollow cylinder shape.

5. An electrochemical device according to claim 4, wherein said fuel source is formed into a round column shape and said fuel electrode is formed into a hollow cylinder shape, and said fuel source is surrounded by said fuel electrode in a state being in contact with said fuel electrode.

6. An electrochemical device according to claim 1, wherein said ion exchange membrane has a porous matrix which is filled with said proton conductor.

7. An electrochemical device according to claim 1, wherein said ion exchange membrane is formed by mixing said proton conductor with a binder and forming the mixture into a film shape.

8. An electrochemical device according to claim 1, wherein said proton conductor is formed by introducing proton dissociative groups in a base body composed of a carbonaceous material containing carbon as a main component.

9. An electrochemical device according to claim 1, wherein said proton conductor is formed of an electrolyte membrane which does not require water management.

10. An electrochemical device according to claim 9, wherein said electrolyte membrane is a self-humidifying type solid polymer membrane.

11. An electrochemical device according to claim 9, wherein said electrolyte membrane is made from a proton conductive inorganic compound.

12. A power generator having a plurality of electrochemical devices, each of said electrochemical devices comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
said plurality of electrochemical devices being electrically connected to each other by means of a conductive connection pattern;
wherein said fuel electrode and said fuel source in at least one of said electrochemical devices constitute a fuel electrode assembly in a state being in contact with each other;
said fuel electrode assembly in at least one of said electrochemical devices is surrounded by said ion exchange membrane in a state being in contact with said ion exchange membrane; and
said ion exchange membrane in at least one of said electrochemical devices is surrounded by said oxygen electrode in a state being in contact with said oxygen electrode.

13. A power generation system having a plurality of electrochemical devices, each of said electrochemical devices comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
said plurality of electrochemical devices being electrically connected to each other by means of a conductive connection pattern;
wherein said plurality of electrochemical devices and said conductive connection pattern are disposed in a housing; and
wherein said fuel electrode and said fuel source in at least one of said electrochemical devices constitute a fuel electrode assembly in a state being in contact with each other;
said fuel electrode assembly in at least one of said electrochemical devices is surrounded by said ion exchange membrane in a state being in contact with said ion exchange membrane; and
said ion exchange membrane in at least one of said electrochemical devices is surrounded by said oxygen electrode in a state being in contact with said oxygen electrode.

14. A power generation system according to claim 13, wherein said housing is provided with an oxygen supply passage or an air supply passage for supplying oxygen or air to said electrochemical devices, and a fuel filling port for supplying a fuel to said fuel sources.

15. An electrochemical device comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
wherein said oxygen electrode is surrounded by said ion exchange membrane in a state being in contact with said ion exchange membrane; and
said ion exchange membrane is surrounded by said fuel electrode in a state being in contact with said fuel electrode; and
wherein said fuel electrode and said fuel source constitute a fuel electrode assembly in a state being in contact with each other; and
said fuel electrode assembly surrounding said oxygen electrode acts only on said oxygen electrode.

16. An electrochemical device according to claim 15, wherein said fuel source is allowed to absorb a liquid fuel or hydrogen gas.

17. An electrochemical device according to claim 16, wherein said fuel source is composed of a hydrogen absorber made from carbon based fullerene molecules, carbon nanotubes, carbon nanofibers, or a metal hydride.

18. An electrochemical device according to claim 15, wherein each of said fuel electrode assembly, said ion exchange membrane, and said oxygen electrode is formed into a hollow cylinder shape.

19. An electrochemical device according to claim 15, wherein each of said fuel source and said fuel electrode is formed into a hollow cylinder shape, and said fuel electrode is surrounded by said fuel source in a state being in contact with said fuel source.

20. An electrochemical device according to claim 15, wherein said ion exchange membrane has a porous matrix which is filled with said proton conductor.

21. An electrochemical device according to claim 15, wherein said ion exchange membrane is formed by mixing said proton conductor with a binder and forming the mixture into a film shape.

22. An electrochemical device according to claim 1, wherein said proton conductor is formed by introducing proton dissociative groups in a base body composed of a carbonaceous material containing carbon as a main component.

23. An electrochemical device according to claim 15, wherein said proton conductor is formed of an electrolyte membrane which does not require water management.

24. An electrochemical device according to claim 23, wherein said electrolyte membrane is a self-humidifying type solid polymer membrane.

25. An electrochemical device according to claim 23, wherein said electrolyte membrane is made from a proton conductive inorganic compound.

26. A power generator having a plurality of electrochemical devices, each of said electrochemical devices comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
wherein said oxygen electrode in at least one of said plurality of electrochemical devices is surrounded by said ion exchange membrane in a state being in contact with said ion exchange membrane; and
said ion exchange membrane in at least one of said plurality of electrochemical devices is surrounded by said fuel electrode in a state being in contact with said fuel electrode; and
wherein said fuel electrode and said fuel source in at least one of said electrochemical devices constitute a fuel electrode assembly in a state being in contact with each other;
said plurality of electrochemical devices are electrically connected to each other by means of a conductive connection pattern; and
said fuel electrode assembly surrounding one of said oxygen electrodes acts only on said one of said oxygen electrodes.

27. A power generation system having a plurality of electrochemical devices, each of said electrochemical devices comprising:
a fuel electrode which becomes a negative electrode while accompanying generation of hydrogen;
an oxygen electrode provided so as to be allowed to be in contact with oxygen, which becomes a positive electrode while accompanying generation of water from oxygen molecules, the hydrogen ions, and electrons;
an ion exchange membrane for conducting the hydrogen ions in said fuel electrode into said oxygen electrode, said ion exchange membrane having a proton conductor; and
a fuel source for supplying a fuel so as to generate the hydrogen ions in said fuel electrodes;
wherein said oxygen electrode in at least one of said plurality of electrochemical devices is surrounded by said ion exchange membrane in a state being in contact with said ion exchange membrane; and
said ion exchange membrane in at least one of said plurality of electrochemical devices is surrounded by said fuel electrode in a state being in contact with said fuel electrode; and
wherein said fuel electrode and said fuel source in at least one of said electrochemical devices constitute a fuel electrode assembly in a state being in contact with each other;
said plurality of electrochemical devices are electrically connected to each other by means of a conductive connection pattern;
said fuel electrode assembly surrounding one of said oxygen electrodes acts only on said one of said oxygen electrodes; and
said plurality of electrochemical devices and said conductive connection pattern are disposed in a housing.

28. A power generation system according to claim 27, wherein said housing is provided with an oxygen supply passage or an air supply passage for supplying oxygen or air to said electrochemical devices, and a fuel filling port for supplying a fuel to said fuel sources.
